(19) United States
(12) Patent Application Publication
(10) Pub. No.: US 2006/0011016 A1
(43) Pub. Date: Jan. 19, 2006

(54) Shackle key

(76) Inventor: Michael Potts, Danbury, CT (US)

Correspondence Address: Michael Potts, 13 Society Hill, Danbury, CT, 06811, US

(21) Appl. No.: 11/178,519

(22) Filed: Jul. 12, 2005

Related U.S. Application Data
(60) Provisional application No. 60/587,263, filed on Jul. 13, 2004.

(51) Int. Cl. E05B 17/00

(52) U.S. Cl. 81/15.9

(57) ABSTRACT

On sailboats and other applications shackles or clevis devices are commonly used to join two flexible members which will be subjected to tension. This hand held tool facilitates the easy rotation of the pins of such devices for the purpose of tightening or loosening them allowing them to be attached and detached. This tool provides an external shape that is obvious to hold in the most suitable orientation and comfortably between thumb and fingers. It includes an irregularly shaped internal hole in which to locate the head of various sizes and designs of shackle/clevis pins, in such a way that this location reduces slipping and allows easy rotation through 180 degrees with a movement of the operators wrist.

The applicant claims the benefit of the provisional application: No: 60/587,263 Date: Jul. 13, 2004 Title: Shackle key.

### FIELD OF INVENTION

This invention relates to a hand held tool to facilitate the rotation of shackle or clevis pins. These shackles are often found joining two flexible members such as ropes, sails and chains on sailboats, and in other applications. More particularly this invention relates to an ergonomic and featured tool, which allows for easy rotation through 180 degrees with movement of the wrist.

### BACKGROUND OF INVENTION

The present invention relates to an improved tool for the purpose of rotating the pins of shackles or clevis devices. Many different shackle head designs are common FIG. 1, and to assist in tightening and loosening them it is common practice to use a shackle key FIG. 1. shackle keys, ‘Shacklers’ are currently used for this purpose and perform exactly the same primary function.

Many of these keys suffer from being large, attached to some form of handle or knife, and are usually made of stainless steel. In use they require a combined arm and wrist movement which has the result of restricting the operation in confined spaces.

Traditional keys can rotate various pins designs but have a tendency to slip on some designs during this rotation. The required movements often makes them inconvenient, and limits rotational movement to 90 degrees. The invention encourages the rotation of 180 degrees afforded by a typical wrist movement, and needed to release certain types of pins.

### SUMMARY OF INVENTION

It is a general object of the invention to provide an improved tool, for the tightening and loosening of shackle/clevis pins, which avoids the disadvantages of the existing shackle keys, whilst affording functional and operational advantages.

The essential features the tool provides, are an easily held shape, the ergonomic transfer of wrist torque to a shackle pin head, and the effective capture of a range of shackle pin heads.

The important features of the tool are a comfortably held external shape which allows for obvious orientation and thumb and finger placement, providing comfort, ergonomic and mechanical advantages. The size facilitates ease of operation in confined spaces to achieve a 180 degree rotation, or more, whilst preventing the pin head from slipping.

The tool has a internal hole of a novel and irregular shape which positively locates various designs of shackle pin heads. The relative location of the internal hole to the external shape provides for suitable positioning of different sizes and shapes.

The design is functional when made out of numerous materials including wood, plastic and metal. The features are fully described and illustrated in the accompanying drawings, and particularly pointed out in the accompanying claims, it being understood that the various changes in detail may be made without departing from the spirit, or sacrificing any of the advantages of the present invention.

### BREIF DESCRIPTION OF DRAWINGS

FIG. 1. Commonly found shackles, 1,2,3,4,5 representing different pin head design, and 6, form of prior art shackle key.

FIG. 2. A perspective view of the invention

FIG. 3. A front view of the tool with identification of its external features.

FIG. 4. A front view of the tool identifying features of its interior hole.

FIG. 5. A front view of a modified design including additional optional features.

### DETAILED DESCRIPTION

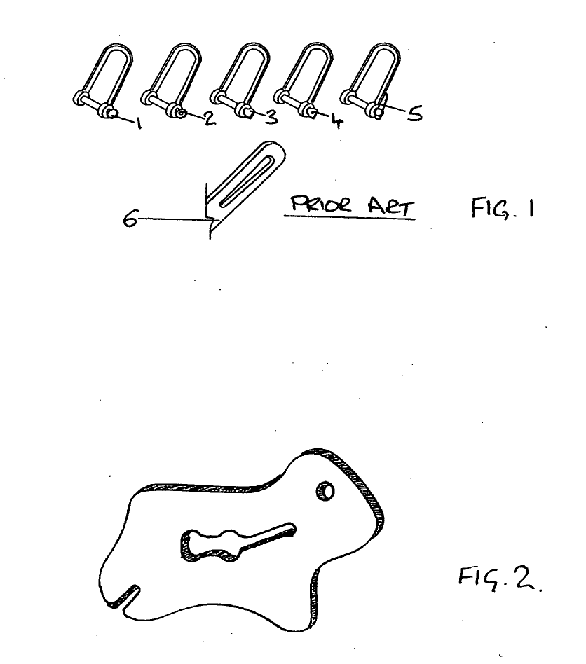

FIG. 1, shows a range of 5 commonly found shackles with different pin head designs, 1,2,3,4,5,. These shackles come in various sizes and thickness. 6 shows a shackle key of common practice form, usually found attached to a handle or knife. The length to width ratio of conventional design does not lend itself to be held in the fingers and the regular internal shape does not locate the pin heads.

FIG. 2, shows the object of the invention in perspective.

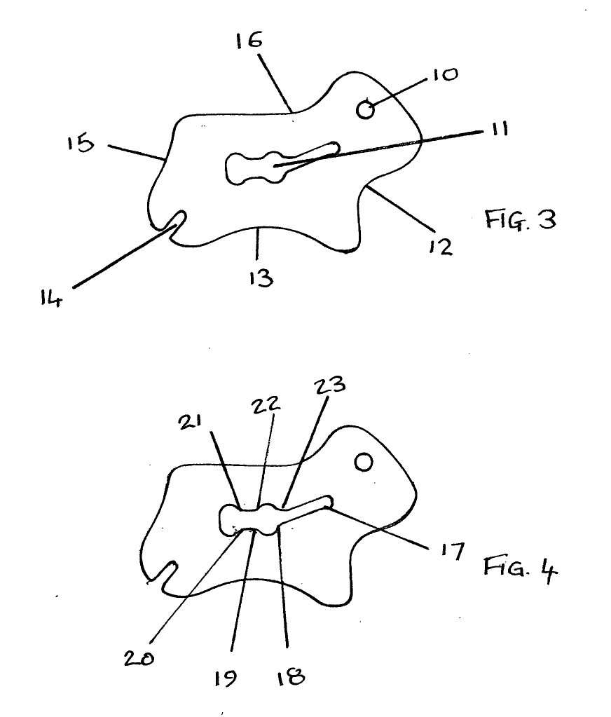

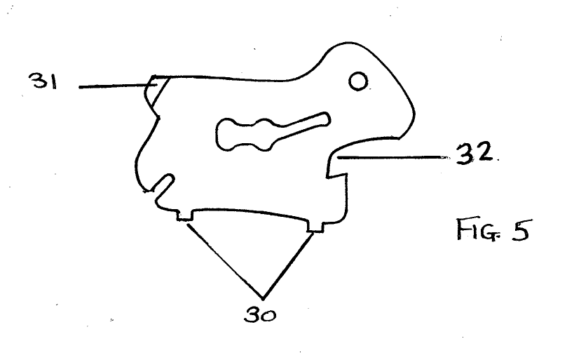

FIG. 3, Shows the object of the invention and its main features. 10 is a through hole for attaching a key ring or lanyard and provides visual orientation, 11 is an interior hole whose features are detailed in FIG. 4. 12,13, and 15 are concave finger locations and 16 is more elongated profile of a thumb. 14 is a slot to allow the tool to be used on various pin heads in restricted access areas. The relative location of the features, 12,13,15,16 is shown. The relative distance between feature 16 and 13, is shown to be significantly larger than the hole 11. This distance acts as a torque multiplier for the rotation of pins captured in hole 11.

FIG. 4, The tool has an interior hole 11 approximately in its center with numerous additional features, 17,18,19,20,21,22,23. These are designed to help capture various sized shackle pin heads during operation, to minimize slippage. The central location of the hole 11 allows torque to be easily applied from the hand to pins captured in the features of it. The alignment of the features, 20,18,23 locate pins of type 5, stopping them from slipping and allowing them to be easily rotated through the 180 degrees necessary to release them.

FIG. 5, shows an alternative embodiment of the present invention maintaining the key features whilst adding additional functional tools useful to the boating and recreational environment, 30, water/fuel cap remover, 31 screwdriver. 32, bottle cap opener.

1. A small tool to facilitate the rotating the pins of shackles/clevis, comprising a flattened, irregular, ergonomic shape, with an irregular hole centered in it.

2. The external shape of the tool in claim 1, wherein the 4 adjacent edges are indented with concave shapes to provide for ergonomic and comfortable holding between thumb and fingers of either hand.

3. The shape of the irregular hole in claim 1, wherein the shape provides indents and projections to locate the head of the pins being loosened or tightened.

4. The shape of claim 2 between the concave shapes on the 4 adjacent surfaces is of a simple form to provide both comfort and aesthetic value to the tool.

5. The Shape of claim 2 has one extended concave shape which will be of a similar profile to a human thumb.

6. The shape of claim 2 provides a profile which is visually obvious about its most suitable orientation for use.

7. The shape of the profile in claim 2 and the hole in claim 3 are such that they are easy to be manufactured by numerous well known process.

8. The relative location of the irregular hole in claim 3 is such that the larger pins are located more centrally between the thumb and fingers to allow for more torque to be applied

9. The distance between the concave indent of claim 5 will be a comfortable and useful distance from the concave indent on the opposite edge.

10. The resulting size and weight of the tool in claim 1 when manufactured in various materials like wood, plastic and metal is appropriate to carry and use.

11. The inclusion of additional features to the tool in claim 1 is easily achieved with slight modifications of the overall profile, without effecting the primary function of the tool.

12. A shackle key substantially as herein described above and illustrated in the accompanying drawings.
